(19) United States
(12) Patent Application Publication
(10) Pub. No.: US 2025/0046591 A1
(43) Pub. Date: Feb. 6, 2025

(54) ION TRAP AND METHOD FOR DETECTING IONS IN AN ION TRAP

(71) Applicant: Edwards Vacuum LLC, Sanborn, NY (US)

(72) Inventor: Nicholai William Salovich, Hillsboro, OR (US)

(21) Appl. No.: 18/716,783

(22) PCT Filed: Dec. 1, 2022
(86) PCT No.: PCT/IB2022/061650

§ 371 Date: Jun. 5, 2024

(30) Foreign Application Priority Data
Dec. 8, 2021 (GB) 2117728.2

(51) Int. Cl. H01J 49/00; H01J 49/42

(52) U.S. Cl. CPC H01J 49/0004; H01J 49/0031; H01J 49/4225

(57) ABSTRACT

A method and ion trap for detecting ions in the ion trap. The method comprises: Providing ionized ions to the ion trap; Creating an RF storage field by applying a RF storage signal to a first electrode of the ion trap, wherein the storage voltage V_{RF} and/or the storage frequency Ω_{RF} of the RF storage signal is modified; Applying an excitation signal to the ions in the ion trap; Detecting an image current signal induced to a second electrode, a third electrode or differentially between the second and third electrodes by oscillation of the ions excited by the excitation signal; and Applying an FFT to the detected image current signal to detect the ion oscillation while recovering the modified signal correctly.

### CROSS-REFERENCE TO RELATED APPLICATION

This application is a Section 371 National Stage Application of International Application No. PCT/IB2022/061650 filed Dec. 1, 2022, and published as WO 2023/105360 A1 on Jun. 15, 2023, the content of which is hereby incorporated by reference in its entirety and which claims priority of British Application No. 2117728.2, filed Dec. 8, 2021.

### FIELD

The present invention relates to a method for detecting ions in an ion trap as well as such an ion trap.

### BACKGROUND

In FFT mass spectrometers, such as quadrupole ion traps, ions can be trapped and their presence can be detected via ion image currents induced into the electrodes of the trap due to the oscillation of the trapped ions. Non-destructive detection of ion image currents is a powerful and robust method option for mass spectrometry. But as compared to destructive methods, image current techniques suffer from the presence of “ghost peaks”, spurious electrical signals due to unavoidable coupling paths to the external environment. Much effort has been dedicated to the reduction of such couplings and to the development of containment techniques for the end user, but fundamental improvements are still urgently needed.

Ghost peaks are known to remain at relatively constant frequencies during the course of a single measurement session, whereas actual ion peaks in an RF ion trap will respond to changes in the trapping signal in a consistent manner. Ion Frequency is given by the equation for the oscillation frequency ω₂:

$${ω}_{z} = \sqrt{2} ( \frac{e}{m} ) ( \frac{1}{{Ω}_{R F}} ) ( \frac{V a c}{{z}_{0}^{2}} )$$

Therein z₀ is the characteristic size of the ion trap, V_{ac} the applied constant AC storage voltage and Ω_{RF} is the angular frequency of the trapping field.

Thus, it is an object of the present invention to provide a method for detecting ions in an ion trap more reliable and with higher sensitivity.

The problem is solved by a method for detecting ions in an ion trap according to claim 1 and an ion trap according to claim 11.

The discussion above is merely provided for general background information and is not intended to be used as an aid in determining the scope of the claimed subject matter. The claimed subject matter is not limited to implementations that solve any or all disadvantages noted in the background.

### SUMMARY

The method according to the present invention for detecting ions in an ion trap comprises the steps of
a. Providing ionized ions to the ion trap;
b. Creating an RF storage field by applying a RF storage signal to a first electrode of the ion trap, wherein the storage voltage V_{RF} and/or the storage frequency Ω_{RF} of the RF storage signal is modified;
c. Applying an excitation signal to the ions in the ion trap;
d. Detecting an image current signal induced to a second electrode, a third electrode or differentially between the second and third electrodes by oscillation of the ions excited by the excitation signal; and
e. Applying an FFT to the detected image current signal to detect the ion oscillation.

Thus, in the beginning ions are provided to the ion trap. Therein, the ions can be either ionized outside the volume of the ion trap or directly within the trap volume of the ion trap. For ionizing the ions any known method for ionization can be used such as electron impact ionization, or plasma ionization or chemical ionization between an ionization gas and the gas to be measured, wherein energy is transferred from the ionization gas due to collision to the gas to be measured for ionization.

The ions are trapped in the trapping volume of the ion trap by creating an RF storage field by applying a RF storage signal to a first electrode of the ion trap. Subsequently, an excitation signal is applied to the ions in order to create a transient signal due to oscillation of the ions in the ion trap. Due to the oscillation of the ions in the ion trap an image current is induced in a second electrode and/or a third electrode wherein the induced image current signal is detected directly from the second electrode, the third electrode or differentially between the second and third electrodes in order to acquire a raw signal. A Fourier transform such as a fast Fourier Transform (FFT) or discrete FFT (DFT) is applied to the detected image current signal in order to identify the ion oscillation and detect the signals resulting from the ion oscillation in the ion trap. By the result of the Fourier Transformation the mass-to-charge ratio (m/z-ratio) of the ions trapped in the ion trap can be determined.

According to the present invention the RF storage signal is modified over time. Therein, either the voltage V_{RF} of the RF storage signal is modified over time. Alternatively or additionally, the storage frequency Ω_{RF} is modified over time. Due to modification of either the storage voltage V_{RF}, the storage frequency Ω_{RF} or both, the eigen frequency ω_{z} of the ions trapped in the ion trap change due to the relation

$${ω}_{z} = \sqrt{2} ( \frac{e}{m} ) ( \frac{1}{{Ω}_{R F}} ) ( \frac{{V}_{RF}}{{z}_{0}^{2}} ) .$$

Therein, ω_{z} is the oscillation frequency of the ion, z₀ is the characteristic trap dimension and Ω_{RF} is the angular frequency of the storage field.

Thus, by modifying the RF storage signal the resulting image current signal is modified in an analogous way which can be detected in the calculated FFT spectrum in order to distinguish between signals coming from the ions in the ion trap and ghost signals or ghost peaks being a result of unwanted coupling path between the individual electrodes and the external environment. While the oscillation frequency of the ions in the ion trap is modified consistently with the modification of the RF storage signal, ghost peaks in the FFT spectrum remain unchanged and thus can be identified and easily be removed.

Preferably, the RF storage signal is periodically modulated with a modulation frequency ωₘ. Thus, the detected image current signal becomes a frequency modulated (FM) signal. For the example of a sinusoidal modulation of the RF storage signal, the oscillation frequency of the ions becomes

$${ω}_{z} = \sqrt{2} ( \frac{e}{m} ) ( \frac{1}{{Ω}_{R F}} ) ( \frac{1}{{z}_{0}^{2}} ) ( {V}_{a c} + {V}_{m} * ( sin ( {ω}_{m} t ) ) ) ,$$

with ωₘ<<Ω_{RF} and V_{ac}>>Vₘ, wherein Vₘ denotes the modulation amplitude and V_{RF} is set to be in this example V_{RF}=V_{ac}+Vₘ+(sin(ωₘt)).

Preferably, the modulation frequency ωₘ is lower than the passband lower limit of a detector or charge amplifier connected to the second electrode and/or the third electrode. The detector or charge amplifier extracts the image current signal from the second electrode and/or the third electrode. Since, the modulation frequencies are outside the passband of the detector or charge amplifier, adverse effects on the detector or charge amplifier is avoided.

Preferably, peaks in the FFT spectrum of the detected image current without sidebands are disregarded. If the RF storage signal is periodically modulated with a frequency ωₘ, the created frequency modulated image current signal can be expressed as a sum of the original carrier signal plus new sidebands corresponding to the original carrier frequency mixed with multiples of the modulation frequency ωₘ. However, ghost peaks will not have any sidebands. By identifying peaks without sidebands, ghost peaks can be identified and disregarded in the FFT spectrum remaining those peaks in the FFT spectrum relating to ions in the ion trap.

Preferably, the method further comprises the steps of identifying peaks in the FFT spectrum of the detected image current and determining instantaneous frequency (IF) of each peak. Subsequently an IQ demodulation scheme (in-phase and quadrature component demodulation scheme) on the IF of each peak is applied. Thereby, either the in-phase (I) of the respective peak, the quadrature component (Q) or the root means square (RMS) of I and Q can be taken from the IQ demodulation scheme. Subsequently, the peak height in the FFT is weighted by the result of the IQ demodulation scheme, such as I, Q or the RMS. Ion peaks in the FFT spectrum that follow the IF from the frequency modulated image current signal will be preserved by this process, whereas noise peaks that do not synchronously demodulate at the original modulation signal will be automatically de-weighted. This also allows to separate ion signals that overlap with ghost peaks, as a I-Q demodulation result will in fact return a signal that is due to the actual ion motion and eliminate the ghost peak contributions. Thus, in the weak modulation limit, this process can eliminate spurious signals and clean up the original mass spectrum.

Preferably, the FFT is applied in a non-stationary or co-moving reference frame. In particular, if the RF storage signal is modified over time such as a periodic modulation, instead of using a conventional FFT, a Fourier transformation can be applied in a co-moving time frame. In this co-moving time frame the modulation frequency may become stationary when choosing the same frequency ωₘ for modulation of the RF storage signal and for the time frame. Thus, unmodulated signals such as ghost peaks are distributed over several different frequencies or frequency bins while modulated signals such as the image current signal of ions in the ion trap follow the evolution in the rotating frame. Then the resultant transform of the data will be concentrated in few frequencies or even a single frequency or frequency bin. Therein, a frequency bin relates to a discrete frequency range in a DFT.

Preferably, prior to applying the FFT the detected image current is multiplied by a factor e^{-iω}^{ₘ}^{t} or similar function that is the complex conjugate of the pre-chosen modulation. By this term the modulation of the RF storage signal is balanced out and the Fourier transform can be performed in a frame rotating at the same rate as the modulation of the RF storage signal.

Preferably, the FFT is a parametric Fourier transformed (PFT) applying the FFT in a rotating reference frame rotated with the modulation frequency ωₘ. Viewed in the time-frequency plane, this parametric Fourier transform has the effect of integrating along frequencies or frequency bins that are themselves oscillating at the modulation frequency. This is equivalent to shifting the analysis into a rotating reference frame. Beyond just concentrating the modulated signal into single bins, this transformation also has the effect of spreading across multiple bins both unmodulated data and data modulated at different frequencies or even different phases. As the modulation index is increased, these unwanted and unmodulated signals will be spread across more and more bins, thus reducing their impact on wanted signals which are of course localized to specific bins.

Preferably, the modulation of the RF storage signal is modulated and in particular chopped off periodically. Therein, coding of the resulting image current signal can be achieved to even more reliably identify those peaks relating to ions detected in the ion trap. In particular, if the modulation level corresponds to the first zero of the Bessel function J₀, the signal strength at the central frequency bin of the nominal peak position will be entirely attenuated. In this case, then for a periodic chopping of the modulation, the measured intensity in that central height from a series of short time (SF) PFFTs matched to the chopping pattern will follow that chopping pattern. A matched series of conventional ST FFTs will then follow the opposite bit pattern from the chopping signal. The chopped ST-PFFT and ST-FFTs may then be synchronously demodulated against the original chopping signal for further enhance of sensitivity.

Preferably, the FFT is a fractional FFT (FRFT) corresponding to a partial rotation between a pure time representation and a pure signal representation, as compared to the 90° rotation performed by a conventional Fourier transform (see https://en.wikipedia.org/wiki/Fractional_Fourier_transform). Therein, the FRFT is applied with a parameter α corresponding to the linear change of the RF storage signal. Thus, by the linear increase of either the storage Voltage V_{RF}, the storage frequency Ω_{RF} or both of the RF storage signal, a linear change of the RF storage signal results in an increasing or decreasing line in the time-frequency plane of the detected image current signal. Therein, the parameter α of the FRFT is matched with this increase or decrease, resulting in a set of frequency bin for a discrete FFT in the time frequency plane which are inclined/declined with the same angle as the modulation of the RF storage signal, i.e. the detected image current signal. Thus, the ion signal is concentrated in one or a small number of frequency bins wherein unwanted and unmodulated signals in the detected raw data are spread across several bins thereby reducing their impact in the measurement result. Thus, for a linear change of the RF storage signal, when applying an FRFT, ghost peaks can be removed from the spectrum as being unmodulated and at the same time signal to noise ratio for the ion signals can be enhanced.

In a further aspect the present invention relates to an ion trap for trapping and detecting ions. The ion trap comprises a first electrode, a second electrode and a third electrode defining a trapping volume. An RF storage signal supply is connected to a first electrode and configured to generate an RF storage field wherein the storage voltage V_{RF} and/or the storage frequency Ω_{RF} of the RF storage signal is modified. A RF excitation signal supply is connected to the first electrode and configured to generate an excitation signal. A detector is connected to the second electrode and/or the third electrode and configured to detect an image current induced by oscillation of the ions excited by the excitation signal.

Preferably, the first electrode is a ring electrode and the second and third electrodes are cap electrodes enclosing the trapping volume of the ion trap.

Preferably, an evaluation unit is connected to the detector wherein the evaluation unit is configured to perform the steps of the method as previously described. Therein, the evaluation unit may be a separate unit to the detector or may be integrally built together with the detector.

The summary is provided to introduce a selection of concepts in a simplified form that are further described in the detailed description. This summary is not intended to identify key features or essential features of the claimed subject matter, nor is it intended to be used as an aid in determining the scope of the claimed subject matter.

### BRIEF DESCRIPTION OF THE DRAWINGS

In the following the present invention is described in more detail with reference to the accompanying figures. The figures show:

FIG. 1 an ion trap according to the present invention,

FIG. 2 a schematic diagram of the method according to the present invention,

FIG. 3 detailed steps of the method according to the present invention,

FIG. 4 a frequency diagram,

FIG. 5 a diagram showing a detection scheme according to the present invention,

FIGS. 6A-6C a detection scheme according to the present invention by Fractional Fourier transform,

FIGS. 7A and 7B a detection scheme according to the present invention by parametric Fourier transform,

FIGS. 8a-8d results of the present invention, and

FIGS. 9a, 9B (a) and 9B (b) a further detection scheme according to the present invention.

### DETAILED DESCRIPTION

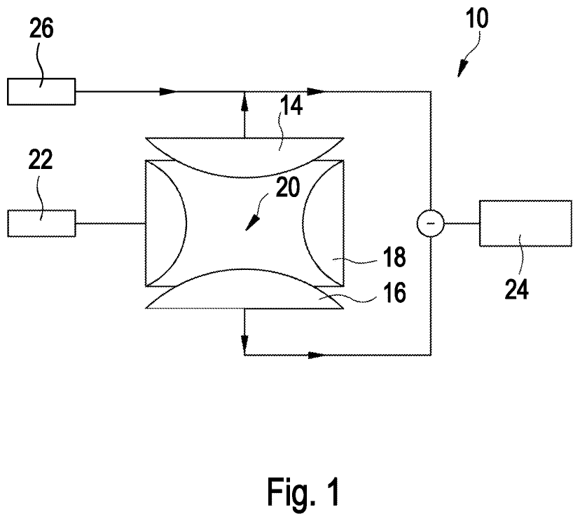

Referring to FIG. 1 showing an ion trap according to the present invention. The ion trap 10 comprises a first electrode 18 built as ring electrode, a second electrode 14 built as first cap electrode and a third electrode 16 built as second cap electrode, wherein the first electrode 18, second electrode 14 and third electrode 16 define a trapping volume 20 in order to trap the ions. A RF signal supply 22 is connected to the first electrode 18, generating a RF storage field between the first electrode 18 and electrodes 14 and 16 to store the ions inside the trapping volume 20. Further, an RF excitation signal supply 26 might be connected to the second electrode 14 and/or the third electrode 16 in order to an excitation signal either as a monopole signal to either electrode 14, 16 or differentially between 14 and 16 prior to detection. As a result of the excitation signal the ions trapped in the trapping volume 20 are excited to oscillate around their equilibrium position in the trapping volume 20 if the frequency of the excitation signal matches the oscillation ion frequency ω_{z} of the respective ions. Therein, the frequency ω_{z} is dependent on the mass of the ions and thus mass selective excitation of oscillation of ions can be facilitated. Due to oscillation of the ions in the trapping volume 20 an image current is induced into the second electrode 14 and the third electrode 16. The ion trap 10 further comprises a detector 24 which might be connected either to the second electrode 14 or to the third electrode 16. Alternatively, as exemplified in FIG. 1 the detector 24 is connected to the second electrode 14 as well as to the third electrode 16 in order to detect the differential signal of the image current induced in the second electrode 14 and third electrode 16. Thus, excitation of the ions can be detected upon detection of the image current signal with the respective frequency in order to determine ions or ion species in the ion trap 10 with a certain m/z-ratio selectively.

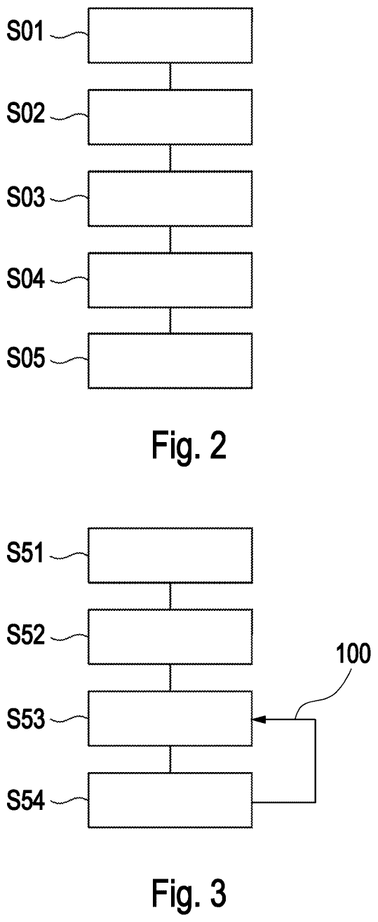

Referring to FIG. 2 showing a flow diagram of the steps of the method. The method for detecting ions in an ion trap, comprises the steps of:
In step S01, providing ionized ions to the ion trap;
In step S02, creating an RF storage field by applying a RF storage signal to a first electrode of the ion trap, wherein the storage voltage V_{RF} and/or the storage frequency Ω_{RF} of the RF storage signal is modified;
In step S03, applying an excitation signal to the ions in the ion trap;
In step S04, detecting an image current signal induced to a second electrode, a third electrode or differentially between the second and third electrodes by oscillation of the ions excited by the excitation signal; and
In step S05, applying an FFT to the detected image current signal to detect the ion oscillation.

Thus, in step S01 ions are provided to the ion trap or the trapping volume of the ion trap. Therein, the ions can be ionized directly inside the trapping volume or can be first ionized outside the ion trap and then transferred to the trapping volume of the ion trap. Therein, any conventional method for producing ions can be used in connection with the present invention.

In step S02 the ions are trapped within the trapping volume of the ion trap by applying a RF storage field which is created by a RF storage signal being applied to the first electrode of the ion trap. Therein, the first electrode 18 of the ion trap may be a ring electrode of a quadrupole ion trap. Therein, the storage voltage V_{RF} is modified over time. Preferably, the storage voltage is periodically modulated with a frequency ωₘ. Alternatively or additionally the storage frequency Ω_{RF} of the RF storage signal is modified over time and also preferably periodically modulated with a frequency ωₘ. Therein, in the case of modulating the storage voltage V_{RF} and the storage frequency Ω_{RF} at the same time, different modulation frequencies ωₘ and ω′ₘ can be applied. However, in a preferred embodiment only the storage voltage V_{RF} or the storage frequency Ω_{RF} are modulated with the same frequency.

In step S03 an excitation signal is applied to the ions in the ion trap to initiate oscillation of the ions.

In steps S04 an image current signal induced into the second electrode 14 and the third electrode 16 is detected wherein the image current signal is caused by oscillation of the ions excited by the excitation signal. Therein, the image current signal can be detected directly from the second electrode 14 or the third electrode 16 or differentially detected between the second and third electrodes 14, 16 of the ion trap. Therein, by modifying the RF storage signal, the oscillation frequency of the excited ions in the ion trap change in correspondence to the modification. Therein, the oscillation frequency of the ions in the ion trap is given by

$${ω}_{z} = \sqrt{2} ( \frac{e}{m} ) ( \frac{1}{{Ω}_{R F}} ) ( \frac{{V}_{RF}}{{z}_{0}^{2}} ) .$$

Thus, modifying either the storage voltage V_{RF} or the storage frequency Ω_{RF} will result in a modified oscillation frequency of the ions.

In step S05 a Fourier transform is applied to the detected image current signal to detect the ion oscillation frequency. Thus, by the Fourier transform the frequency of the ion oscillation can be determined, wherein from frequency of the ion oscillation the mass to charge ratio of the respective ions in the ion trap can be calculated in order to identify the individual species of the ions. Therein, ghost peaks are independent of the modification of the RF storage signal and thus can be identified in the FFT spectrum and eliminated.

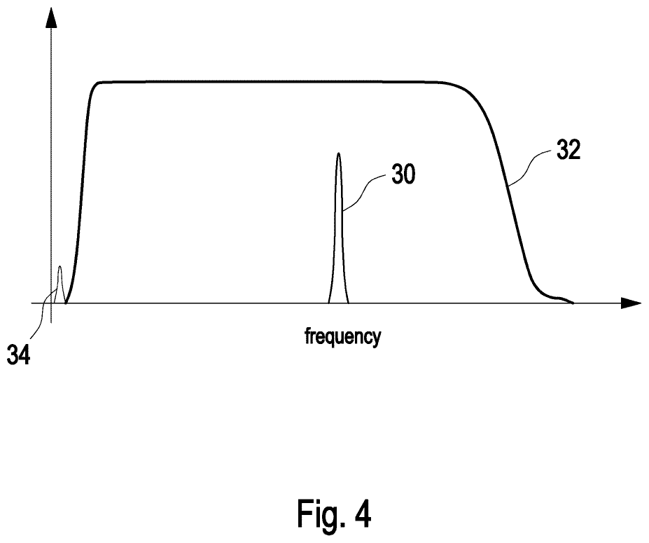

Referring to FIG. 4 showing the situation of the present invention in the frequency regime. An ion signal 30 is within a passband 32 of the detector 24 and thus can be detected by the detector 24. Therein, the RF storage signal is modulated by a frequency 34 which is outside the passband and preferably lower than the lower limit of the passband 32 of the detector 24. Thus, modulation of the RF storage signal does not affect the detector 24 and saturation of the detector due to the modulation of the RF storage signal can be avoided.

In particular, if the RF storage signal is periodically modulated with a low amplitude frequency ωₘ, sidebands occur wherein the low coupling regime only two sidebands at ω_{z}−ωₘ and ω_{z}+Ωₘ appear. For the high modulation regime several sidebands appear. Since the ghost peaks are unaffected by the modulation of the RF storage signal, these ghost peaks show no sidebands in the FFT spectrum. Thus, peaks in the FFT spectrum relating to ions in the ion trap can thus be identified by their sidebands instead of ghost peaks having no sidebands. Thus, peaks in the FFT spectrum without sidebands can be disregarded.

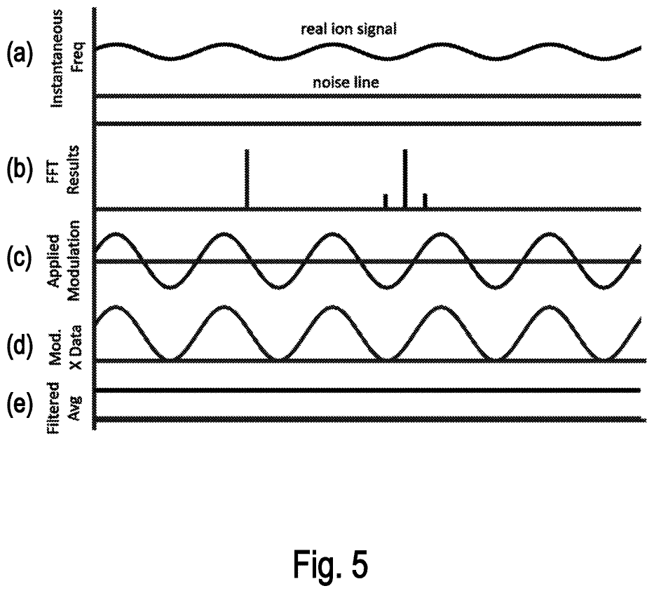

Referring to FIGS. 3 and 5 showing an additional detecting scheme in order identify and eliminate ghost peaks in the acquired FFT spectrum.

In step S51, peaks in the FFT spectrum of the detected image current are identified.

In step S52, the instantaneous frequency (IF) of each peak is determined.

In step S53, an IQ demodulation scheme is applied on the instantaneous frequency of each peak. Therein, the result of the IQ demodulation scheme might be in-phase (I) the quadrature component (Q) or the RMS of I and Q.

In step S54, the respective peak height is weighted by the result of the IQ demodulation scheme.

According to arrow 100 in FIG. 3, the IQ demodulation scheme S53 and the weighting step S54 applied consecutively to each peak in the FFT spectrum.

Referring to FIG. 5 showing an example of the steps of FIG. 3. In FIG. 5a the instantaneous frequency of an exemplified real ion signal and a ghost signal is depicted. In FIG. 5b the FFT spectrum is shown, wherein it is visible that the real ion signal produces sidebands as discussed above wherein the ghost peak does not show any sidebands. Therein, FIG. 5c shows the modulation of the RF storage signal being sinusoidally modulated. FIG. 5d shows the result of a point by point multiplication between the IF of a signal and the applied modulation. IF signals that are not frequency and phase locked to the modulation will average to zero whereas those that maintain lock will produce cosine or sine squared signals that do not average to zero. The IQ demodulation scheme is applied to each of the individual instantaneous frequencies determined according to FIG. 5a. In the example of FIG. 5 the I-Q RMS is applied as weighting to the individual peaks, wherein signals that do not response to the impost modulation are de-weighted from the spectrum. As shown in FIG. 5e a synchronous demodulation of the real ion signal is achieved wherein the noise could be significantly reduced due to reduction of the ghost peaks. Thus, the resulting FFT spectrum as shown in FIG. 5e enhances the peaks resulting from ions in the ion trap and filters out signals not affected by the modulation of the RF storage signal. Thus, ghost peaks can be removed and at the same time the signal-to-noise ratio can be improved.

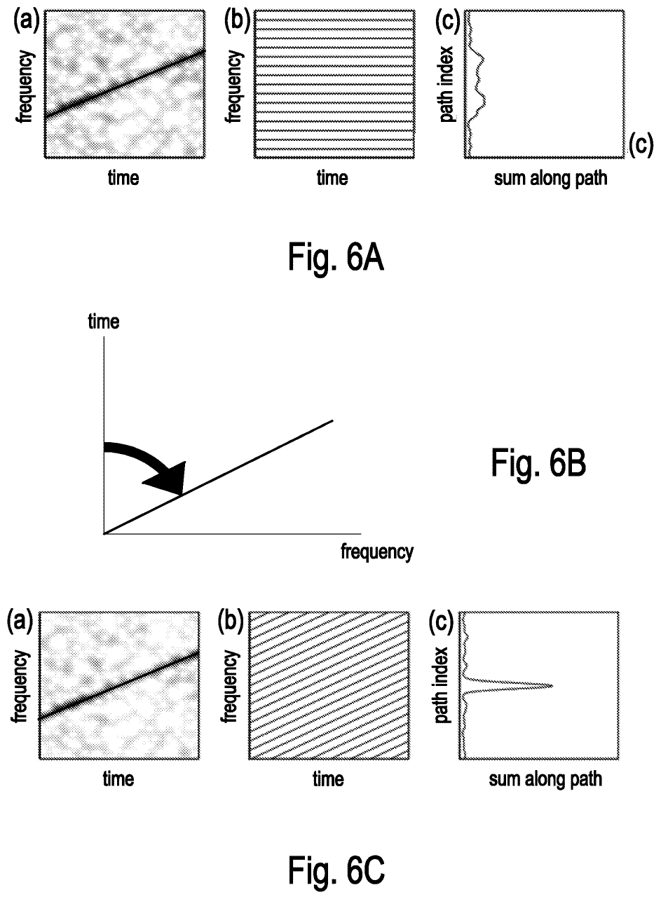

Referring to FIG. 6A to 6C showing another detection scheme. Referring to FIG. 6A, for a linear change of the RF storage signal, in the time frequency plane an inclined line of the detected image current signal is acquired as shown in image a) of FIG. 6A. If a conventional FFT is applied according to the image b) of FIG. 6A showing horizontal frequency bins, the signal of the ions is spread over several frequency bins and in the resulting spectrum shown in image c) of FIG. 6A the ion signals are de-weighted. By the present invention, instead of using a conventional FFT, a fractional FFT (FRFT) is applied to the detected image current signal. FRFT is an arbitrary rotation in the time frequency plane as depicted in FIG. 6B. Therein, FRFT can be considered as Fourier Transform to the nth power, wherein n need not to be integer. In this regard it is referred to “https://en.wikipedia.org/wiki/fractional_fourier_transform” and L. Stankovic et al., “Time-frequency signal analysis with applications”, 2013, Artech House.

Therein, the angle of the frequency bins as depicted in image b) in FIGS. 6A and 6C are inclined by an angle α=nπ/2.

For the case of a linear frequency modulation, FRFT is used instead of conventional FFT. FRFT corresponds to partial rotation between a pure time representation and a pure signal representation, as compared to the ninety-degree rotation performed by a conventional Fourier Transform. Therein, according to the present invention, the inclination angle α of the frequency bins of the FRFT is matched with the inclination angel of the image current signal as depicted in image a) of FIG. 6C by adapted/linear modulation of the RF storage signal. Due to matching of these angles, the signal of the ions is concentrated in one of the frequency bins due to use of the FRFT, resulting in a clear peak shown in image c) of FIG. 6C. Therein, the resulting spectrum is an integration of the image current signal along the respective frequency bins. On the other peaks being unaffected by the modification of the RF storage signal such as ghost peaks, appear in the time frequency plane as a horizontal line. Wherein, in the example of FIG. 6A, when using a conventional Fourier Transform, this would result in a clear peak in the resulting FFT spectrum. Contrary, when using FRFT the unmodified signal will be spread into several frequency bins thereby de-weighting these signals to be filtered out of the resulting FFT spectrum.

Thus, by using FRFT being tailored to the specific modification of the RF storage signal, enhancement of the real ion signal can be achieved wherein at the same time de-weighting of ghost signal peaks in the resulting FFT spectrum can be achieved.

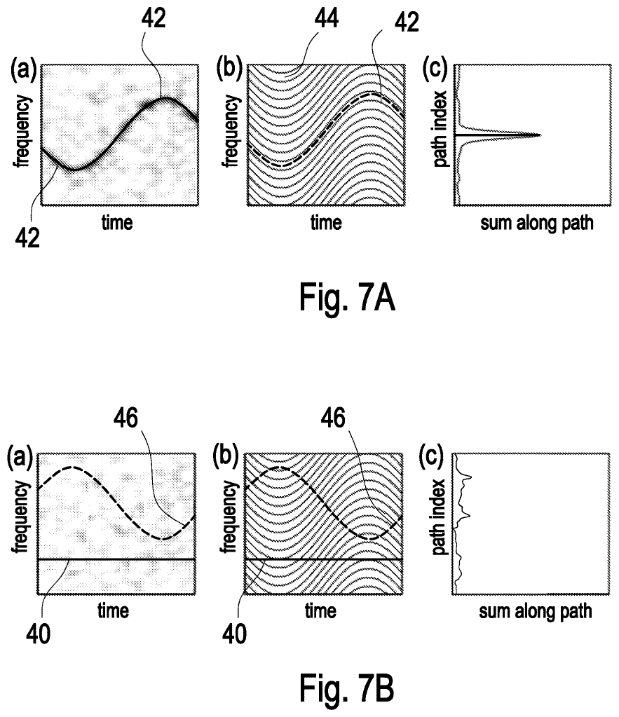

Referring to FIGS. 7A and 7B showing a detection scheme using parametric Fourier Transform. For a non-linear modulation (such as frequency modulation—FM) a parametric Fourier transform can be chosen that is equivalent to performing a conventional Fourier Transform in a frame rotating at the same rate as the modulation (see L. Stankovic et al., “Time-frequency signal analysis with applications”, 2013, Artech House).

Viewed in the time-frequency plane, an unmodulated signal appears as a straight line 40 (see image a) of FIG. 7B), while a modulated signal 42 of an ion in the ion trap appears as a sine wave (see image a) of FIG. 7A). Performing a conventional FFT amounts to calculating the signal intensity found in a certain frequency range or in a set frequency bins, which can be viewed as horizontal divisions in the time-frequency plane. As a consequence frequency modulated signals 42 like those present in FIG. 7A find their intensities divided among multiple bins, and thus de-weighted in apparent spectrum.

If, prior to Fourier transformation, the frequency modulated signal 42 (A(t)e^{iφ(t)} with A(t) the image current signal detected by the detector 24, and φ(t) the phase term relating to the frequency of the modulation ωₘ) is multiplied by a second function (e^{-iφ(t)}) of t, which is chosen so as to balance out φ(t) of the modulated signal, then the resultant transform of the data will be concentrated in a single bin, at the original frequency prior to modulation.

Viewed in the time-frequency plane, this parametric Fourier transform has the effect of integrating along frequency bins 44 that are themselves oscillating at the modulation frequency as depicted in image b) of FIGS. 7A and 7B. This is equivalent to shifting the analysis into a rotating reference frame.

Beyond just concentrating modulated signals into single bins, this transformation also has the effect of spreading across multiple bins both unmodulated signals 40 and signals 46 modulated at different frequencies or even different phases as depicted in FIG. 7B. As the modulation index is increased, these unwanted and unmodulated signals 40,46 will be spread across more and more bins, thus reducing their impact on wanted signals which are of course localized to specific bins. Unwanted and unmodulated signals 40,46 result in dislocated FFT spectrum as depicted in image c) of FIG. 7B, while the modulated current image signal sums up to a clear and pronounced peak as depicted in image c) of FIG. 7A.

That the signal to noise benefits of this frequency modulation approach become more fully realized as the modulation index is increased which also implies that of course the full range of the variation of the instantaneous frequency must remain within the bandwidth of the detector 24 for proper detection. Therein, even very closely spaced frequency ion species can be resolvable by this technique, as the modulation applies to all peaks of the image current signal simultaneously, preventing the overlap of signals from different species.

Thus, by the present detection scheme knowledge about the modulation and its modulation frequency is utilized such that it coherently sums signals that maintain alignment with the driving signal and suppresses signals that are not aligned.

In order to apply parametric Fourier transformation, it is necessary to convert the real-world data into the analytic form. Fortunately, at least for predominately oscillatory data, this can be easily produced as the sum of the real-world data with its Hilbert Transform:

$${s}_{A} ( t ) = s ( t ) + {is}_{h} ( t )$$

For a modulated cosine signal:

$$s ( t ) = cos ( ω t + φ ( t ) )$$

it yields:

$${s}_{h} ( t ) = sin ( ω t + φ ( t ) )$$

and thus results in:

$${s}_{A} ( t ) = s ( t ) + {is}_{h} ( t ) = cos ( ω t + φ ( t ) ) + i * sin ( ω t + φ ( t ) ) . \qquad ( Equation 1 )$$

As can be seen for the example of a modulated cosine function, this process of analytic signal generation allows one to recover phase information that is otherwise unavailable. Refactoring of equation 1 allows one to see how if φ(t) was known, one could choose a multiplying function e^{-iφ(t)} so as to remove this term prior to Fourier transformation by:

$${s}_{a} ( t ) = {e}^{i ( ω t + φ ( t ) )} = {e}^{i ( ω t )} {e}^{i φ ( t ) )} .$$

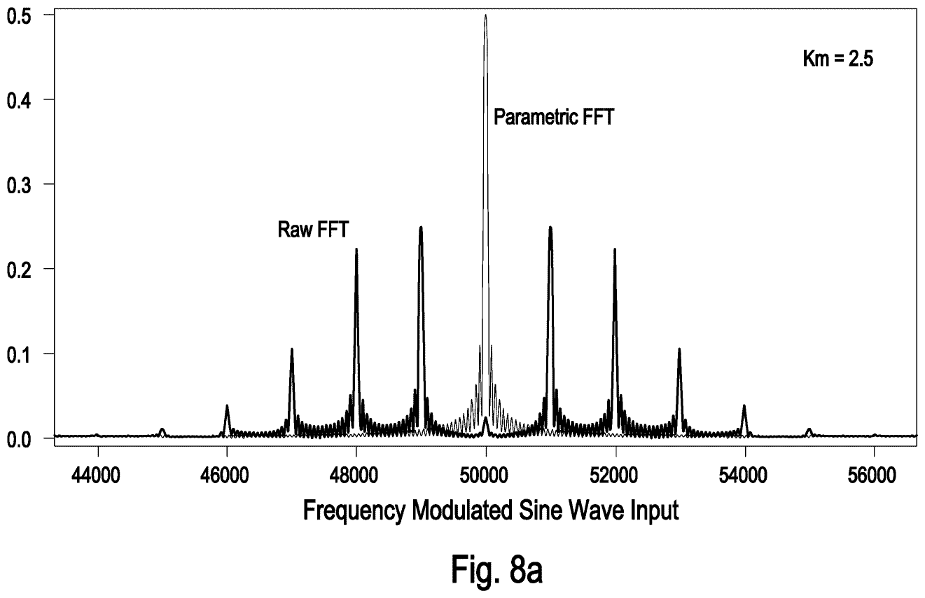

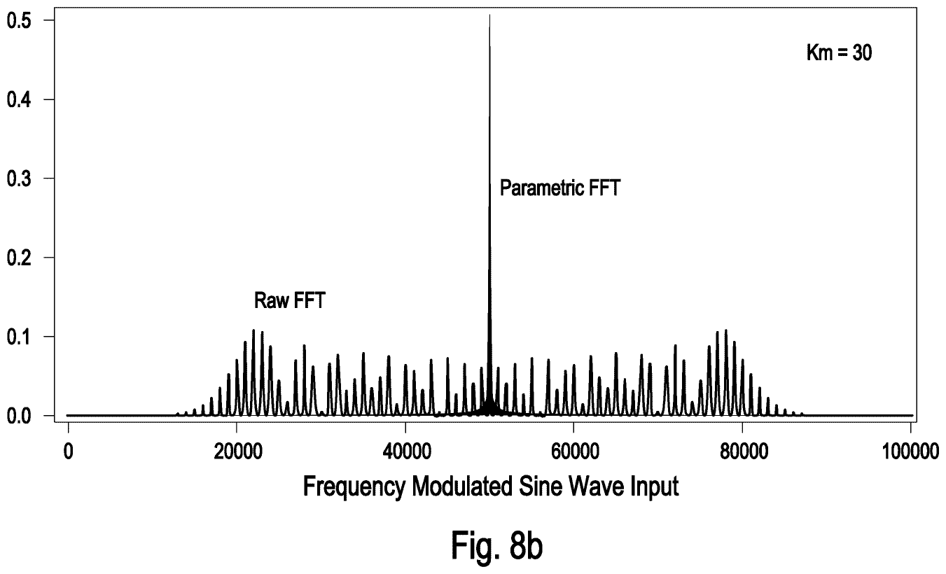

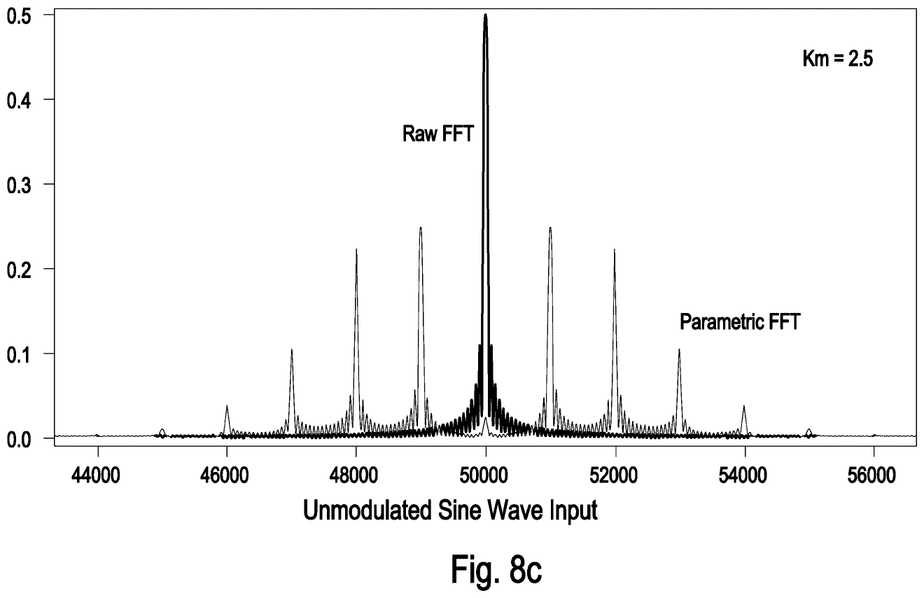

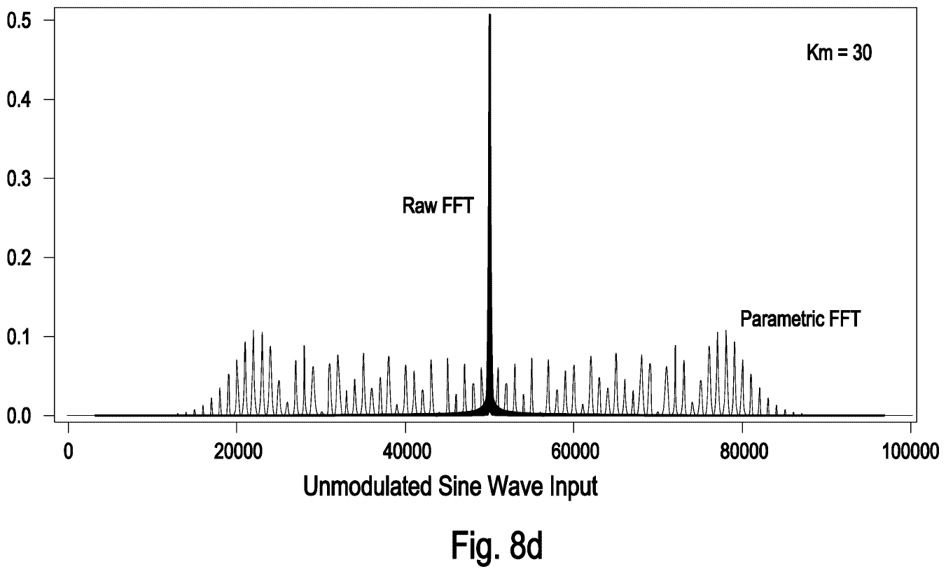

The results of the afore described detecting scheme via parametric FFT are shown in FIG. 8. Therein, FIGS. 8a and 8c relate to the low coupling regime, producing only a small number of sidebands, wherein FIGS. 8b and 8d relate to the strong coupling regime, producing numerous sidebands. FIG. 8a relates to the case that the RF storage signal is sign wave modulated for example by

$${ω}_{z} = \sqrt{2} ( \frac{e}{m} ) ( \frac{1}{{Ω}_{R F}} ) ( \frac{1}{{z}_{0}^{2}} ) ( {V}_{a c} + {V}_{m} * ( sin ( {ω}_{m} t ) ) )$$

with z₀ being the characteristic trap size, Ω_{RF} the angular frequency of the trapping field, and V_{ac} being the constant trapping field voltage modulated by Vₘ*(sin(ωₘt)) in the given example. FIG. 8a shows a comparison between a conventional or raw FFT and the use of a parametric FFT according to the present invention. As it is clearly shown, the detected image current signal using a conventional FFT is spread over several frequencies producing itself sidebands and substantially de-weighting the real ion signal. Contrary, if parametric FFT is used, the existing sidebands are de-weighted and filtered out, wherein the real ion signal is pronounced. The situation is reversed as shown in FIG. 8c, if the RF storage signal is unmodulated. In this case, when still using parametric FFT, the signal is spread over several frequency bins as shown in FIG. 7B, while the conventional FFT produces a clear peak. Similar in FIGS. 8b and 8d for the high modulation regime examples are given, wherein if the RF storage signal is modulated sidebands de-weighted and the peak signal is enhanced, increasing the signal-to-noise ratio. Therein, it is noted that in FIG. 8 only one signal is used as an example which is either modulated according to FIGS. 8a and 8b or unmodulated as shown in FIGS. 8c and 8d.

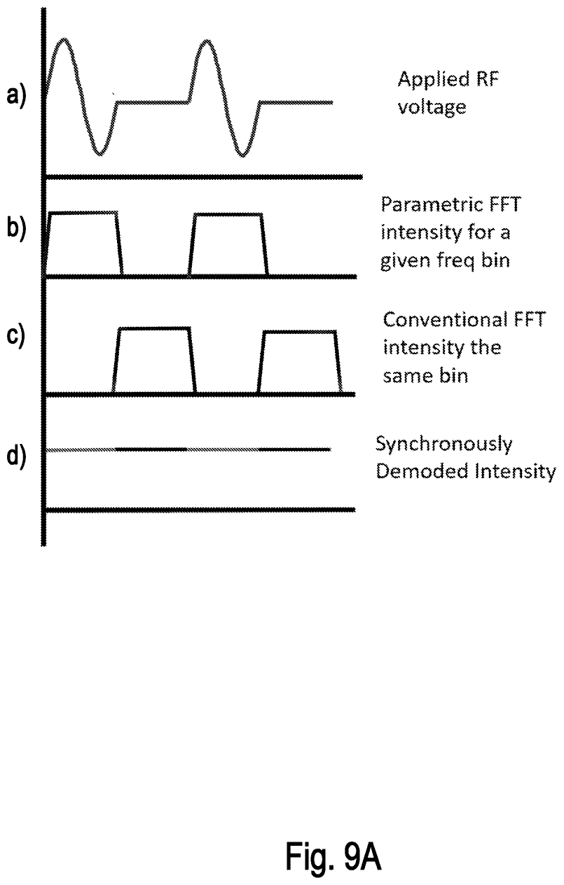

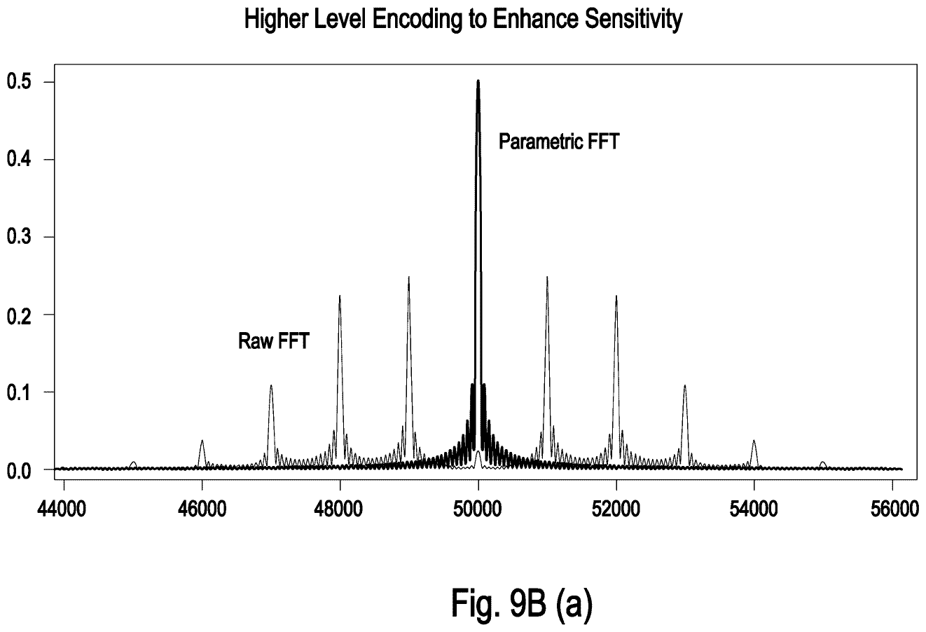

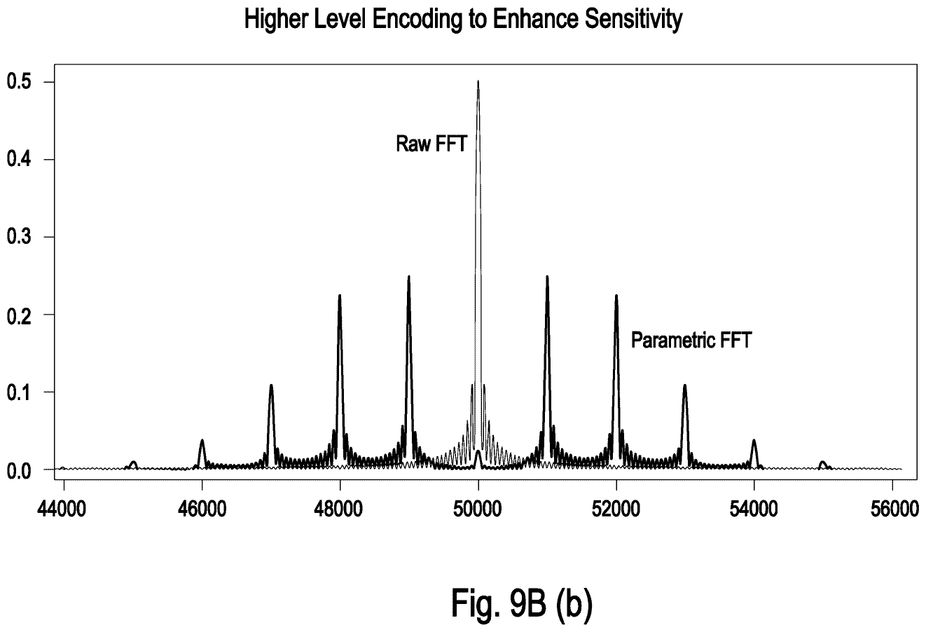

Referring to FIGS. 9A and 9B, the modulation of the RF storage signal can be modulated as for example depicted in FIG. 9Aa. Therein, the example of FIG. 9A the modulation of the RF storage signal is switched on and off comparable to a chopping scheme. If parametric FFT is used during the detection as depicted in FIG. 9Ab, only during the phases of modulation of RF storage signal a relevant peak in the resulting FFT spectrum is achieved. Contrary, in the phases of no modulation as shown in FIG. 9Ac, a peak is achieved if using conventional FFT. Thus, by switching on and off the modulation of the RF storage signal, the resulting spectrum switches between the spectrum of FIGS. 9Ba and 9Bb back and forth. Thus, a synchronously demodulated intensity as depicted in FIG. 9Ad can be achieved, thereby enhancing the signal-to-noise ratio and clearly identifying the signals resulting from ion oscillations in the ion trap.

Thus, by complex modulation of the RF storage signal a tailored response of the image current signal can be acquired which can be used to further enhance the detection either by eliminating ghost peaks or enhancing the signal-to-noise ratio of the resulting ion signal.

Thus, by the present invention the RF storage signal is modulated resulting in a modulated image current signal. Change of the storage voltage or storage frequency results in a corresponding change of the ion frequency. The knowledge about the modulation can be used in the step of determining the ion oscillation frequency either by using an IQ demodulation scheme or by applying a fractional FRFT for a linear change of the RF storage signal. In general, any modulation scheme can be used so long as its complex conjugate can be calculated for use in the parametric Fourier Transform.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A method for detecting ions in an ion trap, comprising:
a. Providing ionized ions to the ion trap;
b. Creating an RF storage field by applying a RF storage signal to a first electrode of the ion trap, wherein the storage voltage V_{RF} and/or the storage frequency Ω_{RF} of the RF storage signal is modified
c. Applying an excitation signal to the ions in the ion trap;
d. Detecting an image current signal induced to a second electrode, a third electrode or differentially between the second and third electrodes by oscillation of the ions excited by the excitation signal; and
e. Applying an FFT to the detected image current signal to detect the ion oscillation.

2. The method according to claim 1, wherein the RF storage signal is periodically modulated with a frequency ωₘ.

3. The method according to claim 2, wherein the modulation frequency is lower than the passband lower limit of a charge amplifier/detector connected to the second electrode and/or the third electrode.

4. The method according to claim 2, wherein peaks in the FFT-spectrum of the detected image current without sidebands are disregarded.

5. The method according to claim 2,
wherein the method comprises the further steps of:
Identifying peaks in the FFT-spectrum of the detected image current signal;
Determine the instantaneous frequency (IF) of each peak;
Apply an IQ-demodulation scheme on the IF of each peak;
Weight the peak height by the result of the IQ-demodulation scheme.

6. The method according to claim 2, wherein the FFT is applied in a non-stationary reference frame.

7. The method according to claim 2, wherein prior to applying the FFT, the detected image current is multiplied by the complex conjugate of the applied modulation signal, preferably as e^{-iω}^{ₘ}^{·t}.

8. The method according to claim 2, wherein the FFT is a parametric Fourier transform (PFT) applying the FFT in a rotating reference frame rotated with the modulation frequency ωₘ.

9. The method according to claim 2, wherein the modulation of the RF storage signal is modulated and in particular chopped of periodically.

10. The method according to claim 1, wherein the FFT is a fractional FFT (FRFT), with a parameter α corresponding to the linear change of the RF storage signal.

11. An ion trap for trapping and detecting ions, comprising:
a first electrode, a second electrode and a third electrode defining a trapping volume;
a RF storage signal supply connected to the first electrode and configured to generate an RF storage field wherein the storage voltage V_{RF} and/or the storage frequency Ω_{RF} of the RF storage signal is modified;
a RF excitation signal supply is connected to the first electrode and configured to generate an excitation signal; and
a detector connected to the second electrode and/or the third electrode and configured to detect an image current induced by oscillation of the ions excited by the excitation signal.

12. The ion trap according to claim 11, wherein the first electrode is a ring electrode and the second electrode and third electrode are cap electrodes.

13. The ion trap according to claim 11, wherein an evaluation unit is connected to the detector, wherein the evaluation unit is configured to apply an FFT to the detected image current signal to detect the ion oscillation.
